(19) United States
(12) Patent Application Publication
(10) Pub. No.: US 2018/0349873 A1
(43) Pub. Date: Dec. 6, 2018

(54) DEVICE CONTROL APPARATUS AND METHOD OF CONTROLLING DEVICE CONTROL APPARATUS

(71) Applicant: Seiko Epson Corporation, Tokyo (JP)

(72) Inventors: Dai TANAKA, Matsumoto-shi (JP); Koji Hashimoto, Matsumoto-shi (JP); Yoshinori Oshima, Matsumoto-shi (JP); Keigo Mori, Matsumoto-shi (JP); Yuki Washizu, Matsumoto-shi (JP)

(73) Assignee: Seiko Epson Corporation, Tokyo (JP)

(21) Appl. No.: 16/000,586

(22) Filed: Jun. 5, 2018

(30) Foreign Application Priority Data
Jun. 6, 2017 (JP) 2017-111849

(51) Int. Cl. G06Q 20/20; G06K 7/10; G07G 1/14

(52) U.S. Cl. CPC G06Q 20/20; G07G 1/14; G06K 7/10851

(57) ABSTRACT

A control apparatus includes an HTTP server that communicates with a terminal, a device interface that communicates with a device, a first device control unit on which a device driver corresponding to the device is mounted, a second device control unit that uses a driver that is able to correspond to the device, and a process unit that selects the first device control unit or the second device control unit based on control information received from the terminal by the HTTP server, generates a command based on the control information, and transmits the generated command to the device by the device interface.

### CROSS REFERENCES TO RELATED APPLICATIONS

The present invention contains subject matter related to Japanese Patent Application No. 2017-111849 filed in the Japanese Patent Office on Jun. 6, 2017, the entire contents of which are incorporated herein by reference.

### BACKGROUND

### 1. Technical Field

The present invention relates to a device control apparatus and a method of controlling the device control apparatus.

### 2. Related Art

In the related art, a system that controls a device connected to a control apparatus by equipment connected to the control apparatus through a network has been known (for example, refer to JP-A-2014-147045). The system described in JP-A-2014-147045, a device such as a bar code scanner or the like is connected to the control apparatus, and the control apparatus executes communication with a tablet terminal. The control apparatus executes a control object that is a program module that controls the device based on a requirement of the tablet terminal.

In the system described in JP-A-2014-147045, the control apparatus to which the device is connected has a program module suitable for specifications of both the device and the control apparatus. In a case where so-called a dedicated program module suitable for the control apparatus is used, it is possible to improve an efficiency of a process in the control apparatus. However, it is necessary to prepare the dedicated module of the control apparatus for each device and a reduction in a burden is desired.

### SUMMARY

An advantage of some aspects of the invention is to reduce a burden required for preparing a program module in a device control apparatus that executes the program module for controlling a device and controls the device.

According to this application example of the invention, there is provided a device control apparatus including a first communication unit that communicates with a terminal, a second communication unit that communicates with a device, a first device control unit on which a first control module corresponding to the device is mounted, a second device control unit that uses a second control module that is able to correspond to the device, and a process unit that selects the first device control unit or the second device control unit based on control information received from the terminal by the first communication unit, generates a command based on the control information, and transmits the generated command to the device by the second communication unit.

In the configuration, when the device connected to the device control apparatus is controlled, it is possible to select the first device control unit on which the first control module is mounted and the second device control unit using the second control module. Since the first control module is a control module corresponding to the device and the second control module is a control module that is able to correspond to the device, for example, it is possible to use the second control module as a general purpose control module. Therefore, in order to control the device, for example, it is possible to use the second control module that is a general purpose control module and the first control module. Thus, it is possible to reduce a burden of procuring the control module corresponding to the device and it is possible to use various devices.

In addition, in the device control apparatus, a storage unit that stores device control management information indicating a correspondence between a device identifier for identifying the device and the first device control unit or the second device control unit may be included. The process unit may select the first device control unit or the second device control unit by referring to the device control management information of the storage unit based on the device identifier included in the control information received from the terminal, and transmit the command to the device designated by the device identifier included in the control information.

In the configuration, it is possible to suitably select the first device control unit on which the first control module is mounted and the second device control unit using the second control module corresponding to the device.

In addition, in the device control apparatus, the storage unit may have device communication management information indicating a correspondence between the device identifier and the terminal. The process unit may determine whether or not the device designated by the device identifier included in the control information is able to execute communication, by referring to the device communication management information of the storage unit based on the device identifier included in the control information received from the terminal, and in a case where it is determined that the device designated by the device identifier is able to execute the communication, the process unit may select the first device control unit or the second device control unit.

In the configuration, in a case where the device designated by the terminal is able to execute the communication, since the command is transmitted by selecting the first device control unit or the second device control unit, it is possible to improve an efficiency of the control of the device.

In addition, in the device control apparatus, the process unit may be able to execute at least one of an addition, an update, and a deletion of the device control management information and the device communication management information stored in the storage unit based on management information received from the terminal by the first communication unit.

In the configuration, since the addition, the update, the deletion, and the like for information on a control target device are possible, it is possible to efficiently control the device.

In addition, in the device control apparatus, the process unit may include a selection unit that selects the first device control unit and the second device control unit, a first process unit that transmits the command to the device based on a process result of the first control module mounted on the first device control unit in a case where the first device control unit is selected by the selection unit, and a communication module that transmits second device control information to the second device control unit based on the control information received from the terminal in a case where the second device control unit is selected by the selection unit. The second device control unit may generate control data corresponding to the second control module based on the second device control information received from the communication module.

In the configuration, since the second device control unit receives the second device control information through the communication module, even a specification of the second control module is different from that of the first control module, it is possible to reliably cause the second control module to function.

In addition, in the device control apparatus, a table that defines the control data for each second control module may be included. The second device control unit may convert the second device control information received from the communication module into the control data corresponding to the second control module, by referring to the table.

In the configuration, it is possible to convert the control data into corresponding data with respect to each of a plurality of second control modules. Therefore, it is possible to cause the second control modules of various specifications to function, and it is possible to control various devices.

In addition, in the device control apparatus, the second control module may generate a unique command to the device based on the control data input from the second device control unit.

In the configuration, since it is possible to control a device that requires the unique command, it is possible to use wider variety of devices.

In addition, in the device control apparatus, the communication module may be configured as a wrapper for relaying communication between the process unit and the second device control unit.

In the configuration, it is possible to more suitably input the second control information to the second device control unit by the communication module mounted as the wrapper.

In addition, according to this application example of the invention, there is provided a method of controlling a device control apparatus including a first communication unit that communicates with a terminal and a second communication unit that communicates with a device. The method includes selecting a first device control unit on which a first control module corresponding to the device is mounted or a second device control unit that uses a second control module that is able to correspond to the device based on control information received from the terminal by the first communication unit, generating a command based on the control information received from the terminal, and transmitting the generated command to the device by the second communication unit.

In the configuration, when the device connected to the device control apparatus is controlled, it is possible to select the first device control unit on which the first control module is mounted and the second device control unit using the second control module. Since the first control module is a control module corresponding to the device and the second control module is a control module that is able to correspond to the device, for example, it is possible to use the second control module as a general purpose control module. Therefore, in order to control the device, for example, it is possible to use the second control module that is a general purpose control module and the first control module. Thus, it is possible to reduce a burden of procuring the control module corresponding to the device and it is possible to use various devices.

### BRIEF DESCRIPTION OF THE DRAWINGS

The invention will be described with reference to the accompanying drawings, wherein like numbers reference like elements.

FIG. 1 is a configuration block diagram of a POS system according to the present embodiment.

FIG. 2 is a block diagram showing a functional configuration of each device configuring the POS system.

FIG. 3 is a functional block diagram of a browser execution unit and a device control unit.

FIG. 4 is a schematic diagram showing an operation of a control apparatus.

FIG. 5 is a schematic diagram showing a configuration example of a device control unit management table.

FIG. 6 is a schematic diagram showing a configuration example of a device communication management table.

FIG. 7 is a sequence diagram showing an operation of the POS system.

FIG. 8 is a flowchart showing the operation of the POS system.

FIG. 9 is a flowchart showing the operation of the POS system.

FIG. 10 is a flowchart showing the operation of the POS system.

FIG. 11 is a flowchart showing the operation of the POS system.

FIG. 12 is a flowchart showing the operation of the control apparatus.

FIG. 13 is a flowchart showing the operation of the POS system.

### DESCRIPTION OF EXEMPLARY EMBODIMENTS

Hereinafter, an embodiment of the invention will be described with reference to the drawings.

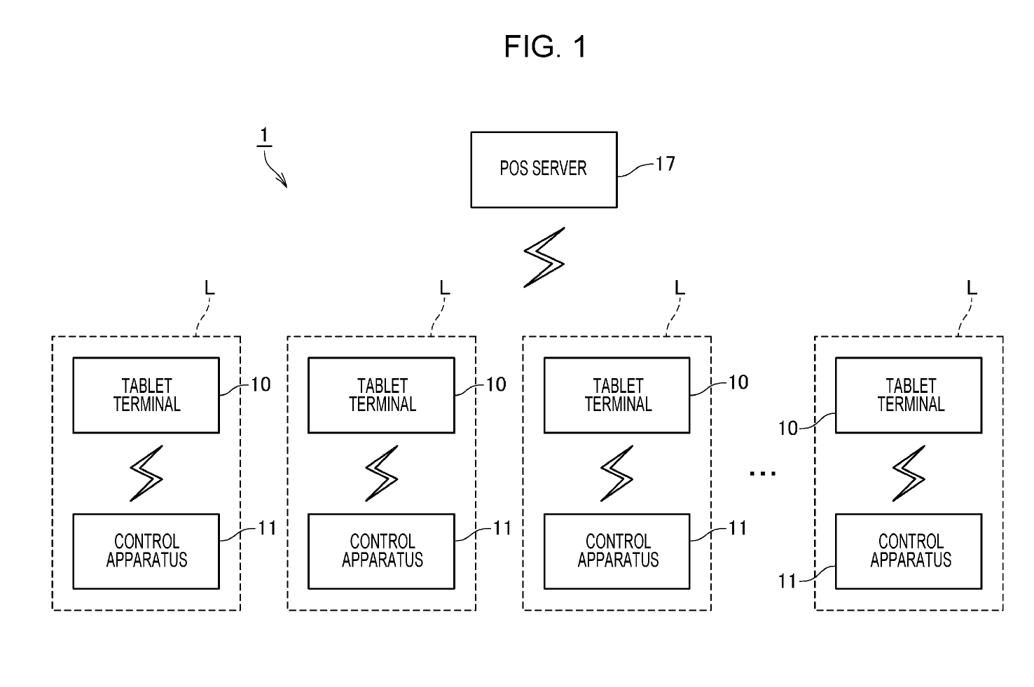

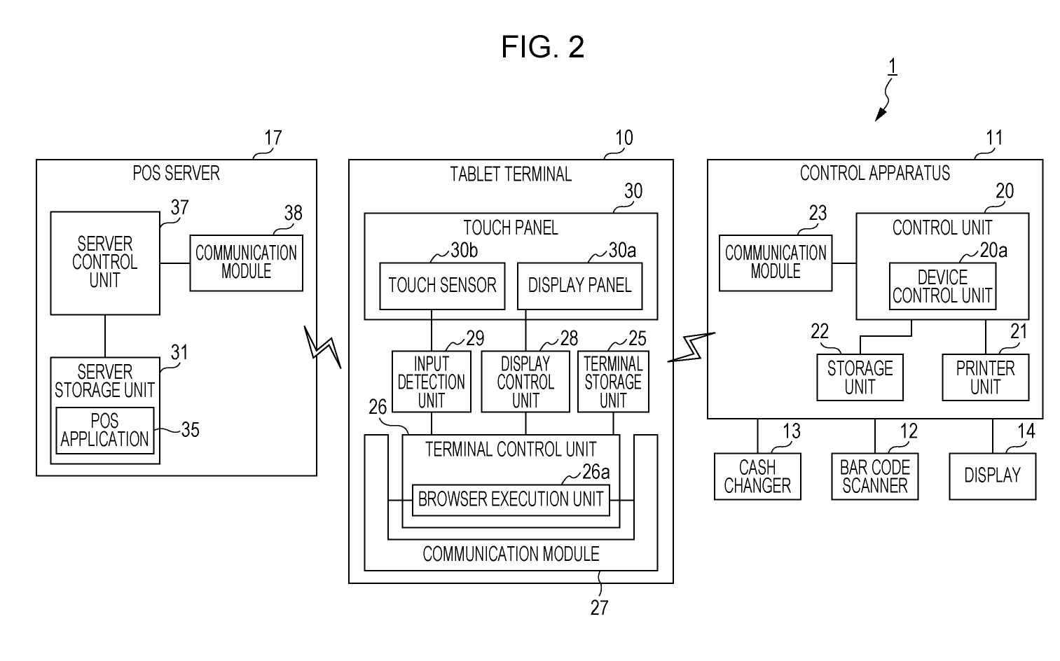

FIG. 1 is a schematic configuration block diagram of a Point Of Sales (POS) system 1 (control system) according to the present embodiment. In addition, FIG. 2 is a block diagram showing a functional configuration of a tablet terminal 10 (terminal), a control apparatus 11, and a POS server 17 configuring the POS system 1.

The POS system 1 is a system applied to a retail shop such as a shopping center, a department store, a convenience store, or the like, an eating and drinking place such as a restaurant, a coffee shop, a pub, or the like, other shops, and other facilities. Examples of a function of the POS system 1 include a function of managing a sale situation of a product, a stock situation of a product, a sales situation, and the like in a shop. In addition, the examples of the function of the POS system include a function of executing accounting according to a product purchased by a customer, a function of issuing a receipt according to a payment of a money by a customer, a function of providing accounting information to a customer, and the like in a register counter L installed in a shop.

In a shop to which the POS system 1 according to the present embodiment is applied, a register counter L that executes an accounting process is provided. In addition, in one register counter L, one control apparatus 11 and the tablet terminal 10 connected to the control apparatus 11 so as to be able to execute wireless communication are provided.

The tablet terminal 10 is a terminal used by a register person in charge of accounting in the register counter L, and is, for example, a portable computer. In the present embodiment, an example in which the tablet terminal 10 that is a tablet type (plate) computer is shown. On the front surface of the tablet terminal 10, a touch panel 30 capable of displaying a screen and detecting a touch operation is disposed, and various inputs are possible by the touch operation on the touch panel 30.

The tablet terminal 10 provides a user interface to the register person at the time of the accounting in the register counter L.

The control apparatus 11 is an apparatus having a function as a device control apparatus. As shown in FIG. 2, at least one device is connected to the control apparatus 11. The device may include a bar code scanner 12 (device) that reads a bar code attached to a product or a package of a product. In addition, the device may include a cash changer (device) that accommodates and manages a bill, money, a cash voucher, and the like. In addition, the device may include a display 14 (device) that displays the information on the accounting to a customer. In a case where the bar code scanner 12, the cash changer 13, and the display 14 are not distinguished, the bar code scanner 12, the cash changer 13, and the display 14 are collectively referred to as the device. In addition, a printer unit 21 that will be described later may be included in the device.

As shown in FIG. 2, the control apparatus 11 includes a control unit 20, the printer unit 21 (a printer, a printing unit, the device), a storage unit 22, and a communication module 23.

The control unit 20 controls each unit of the control apparatus 11, and includes a processor such as a CPU. The control unit 20 may include a ROM that stores a program or data executed by the processor in a nonvolatile manner, a RAM that forms a work area for the processor, and the like. In addition, the control unit 20 may include a peripheral circuit of other processors. The control unit 20 includes a device control unit 20a. The device control unit 20a will be described later.

The printer unit 21 includes a transport mechanism that transports a roll paper, a print mechanism that prints a character or an image on the roll paper by a thermal head, a cutting mechanism that cuts the roll paper, and the like. The printer unit 21 is a print device for issuing a receipt in the register counter L, and prints an image related to the receipt on the roll paper according to a control of the control apparatus 11.

The storage unit 22 is a storage device configured of a semiconductor memory device, a magnetic recording device, an optical recording device, and the like. The storage unit 22 stores the program executed by the control unit 20 and/or the data processed by the control unit 20 in a nonvolatile manner so that the storage unit 22 is rewritable.

The communication module 23 includes a wireless communication module such as a network card conforming to a predetermined communication standard, a circuit, and the like, and realizes the wireless communication conforming to the predetermined communication standard with the tablet terminal 10 under a control of the control unit 20.

In addition, the tablet terminal 10 includes a terminal storage unit 25, a terminal control unit 26, a communication module 27, an input detection unit 29, and a touch panel 30. In addition, the terminal control unit 26 includes a display control unit 28.

For example, the terminal storage unit 25 is configured of a semiconductor memory device such as an EEPROM, and stores various data in a nonvolatile manner so that the terminal storage unit 25 is rewritable.

The touch panel 30 is configured by integrating a display panel 30a disposed on the front surface of the tablet terminal 10 and a touch sensor 30b overlapping the display panel 30a.

The display panel 30a is a display such as a liquid crystal display panel, an organic EL panel, and an electronic paper, and is driven by the display control unit 28. The touch sensor 30b is a sensor that is disposed to overlap the display panel 30a and detects a touch operation and/or a pressure operation. For example, the touch sensor 30b may be configured of a capacitive sensor or a pressure sensitive sensor. The touch sensor 30b detects a touch operation by a user's finger or pen type operation device, and outputs a signal indicating the position where the touch operation is detected to the input detection unit 29. The touch panel 30 corresponds to “a display unit that displays a browser”.

The display control unit 28 drives the display panel 30a based on display data input from a browser execution unit 26a that will be described later, and displays a screen including a character and an image on the display panel 30a.

The input detection unit 29 detects the touch operation on the touch panel 30 based on a signal output from the touch sensor 30b. In a case where the touch operation is detected, the input detection unit 29 generates coordinate data indicating the operation position by coordinates corresponding to the display position of the display panel 30a, and outputs the coordinate data to the terminal control unit 26.

The communication module 27 includes a wireless communication module such as a network card conforming to a predetermined communication standard, a circuit, and the like. The communication module 27 realizes the wireless communication conforming to the predetermined communication standard with the control apparatus 11 and the POS server 17 under a control of the terminal control unit 26.

The terminal control unit 26 controls each unit of the tablet terminal 10, and includes a processor such as a CPU. The terminal control unit 26 may include a ROM that stores a program or data executed by the processor in a nonvolatile manner, a RAM that forms a work area for the processor, and the like. In addition, the terminal control unit 26 may include a peripheral circuit of other processors. The terminal control unit 26 includes the browser execution unit 26a that realizes a function of a browser by executing a browser program.

The browser execution unit 26a executes communication by a protocol such as an HTTP by a function of the web browser, and downloads a web page (HTML file, or the like) described in a script language or a markup language such as an HTML from the POS server 17. For example, data of the downloaded web page is stored in a RAM that is not shown. The browser execution unit 26a reads the data of the downloaded web page generates display data for displaying the web page, and outputs the display data to the display control unit 28. The display control unit 28 displays an image of the web page related to the display data on the display panel 30a based on the input display data.

In a case where the touch operation of the touch sensor 30b is detected by the input detection unit 29, the browser execution unit 26a specifies input contents based on the coordinate data input from the input detection unit 29 and corresponding to the touch operation, and the display data output to the display control unit 28. The browser execution unit 26a suitably executes a suitable process by, for example, a function of a script, based on the specified input contents.

The POS server 17 includes a server storage unit 36 including a database that stores information on a product, a database that manages sales, a database that manages a stock, and the like, and manages the entire POS system 1 using such databases.

The POS server 17 includes a server control unit 37, the server storage unit 36, and a communication module 38.

The server control unit 37 controls each unit of the POS server 17, and includes a processor such as a CPU. The server control unit 37 may include a ROM that stores a program or data executed by the processor in a nonvolatile manner, a RAM that forms a work area for the processor, and the like. In addition, server control unit 37 may include a peripheral circuit of other processors.

The server storage unit 31 is a storage device configured of a semiconductor memory device, a magnetic recording device, an optical recording device, and the like. The server storage unit 31 stores the program executed by the server control unit 37 and/or the data processed by the server control unit 37 in a nonvolatile manner so that the server storage unit 31 is rewritable.

The communication module 38 includes a wireless communication module such as a network card conforming to a predetermined communication standard, a circuit, and the like, and realizes the wireless communication conforming to the predetermined communication standard with the tablet terminal 10 under a control of the server control unit 37.

In the POS server 17, a POS application 35 is installed.

The browser execution unit 26a of the tablet terminal 10 executes various processes using a function of the POS application 35 on the POS server 17.

Specifically, the browser execution unit 26a suitably executes a requirement of an arithmetic process of the POS server 17, executes the arithmetic process by the function of the POS application 35, receives a process result, and executes a suitable process. For example, the browser execution unit 26a outputs a reading result of the bar code scanner 12 to the POS server 17, and executes a product search by the function of the POS application 35. The browser execution unit 26a receives a search result, controls the control apparatus 11, and displays the product information on the display 14. In addition, the browser execution unit 26a requests a calculation of a total amount of money of accounting, calculates the total amount of money by the function of the POS application 35, receives a calculation result, controls the control apparatus 11, and issues a receipt on which information including the total amount of money is printed.

Here, “an application operated by the browser” is an application installed in another equipment with which the browser execution unit 26a may communicate, and includes a concept including an application having a function that may be used by the browser execution unit 26a. For example, “the application operated by the browser” corresponds to the POS application 35. The application of this case may be an application that is executed and operated on the other equipment that may execute the communication described above and may be an application that is downloaded from the corresponding other equipment, and is executed and operated on the tablet terminal 10. In addition, “the application operated by the browser” is a concept including a script mounted in a web page (HTML file) read by the browser execution unit 26a, a program and a software having functions that may be used by the browser execution unit 26a, and the like.

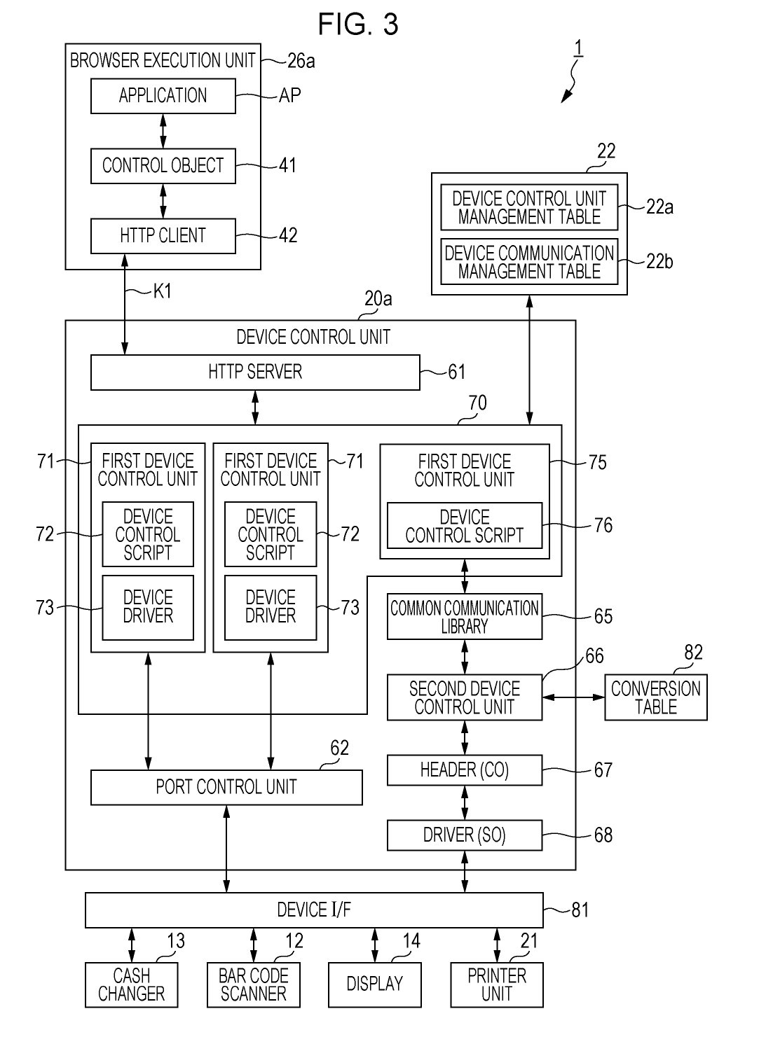

FIG. 3 is a diagram showing a functional block of the browser execution unit 26a of the tablet terminal 10 (functional block corresponding to “terminal control unit”), and the device control unit 20a of the control apparatus 11 in more detail. In addition, in FIG. 3, for convenience of understanding related to the device control unit 20a, the storage unit 22 is shown together.

In FIG. 3, for convenience of description, a program, a software object, a block conceptually representing a function realized by a program, and a physical device such as a device are expressed as the same level.

In addition, in the following description, an “object” refers to an instance in object oriented programming. That is, the “object” refers to a software target defined as a set of data and methods. This description is an example, and the “object” is not limited to the instance in the object oriented programming but may be a software target that may realize any function.

As shown in FIG. 3, in the browser execution unit 26a of the tablet terminal 10, an application AP is operated. The application AP is a concept including a program and software having functions that may be used by the browser execution unit 26a. Specifically, as described above, the application AP includes an application that is operated in another equipment or downloaded from the other equipment like the POS application 35, a script mounted in an HTML file read by the browser execution unit 26a, or the like.

In the browser execution unit 26a, a control object 41 may be operated.

The control object 41 is an object for controlling a device connected to the control apparatus 11. Examples of the control object 41 include a bar code scanner interface (I/F) object that controls the bar code scanner 12, and a cash changer I/F object that controls the cash changer 13. In addition, examples of the control object 41 include a display I/F object that controls the display 14, a printer I/F object that controls the printer unit 21, and the like. The control object 41 includes at least one of the objects described above. Such objects are suitably generated corresponding to the operation for the tablet terminal 10 or the communication between the control apparatus 11 and the tablet terminal 10.

In the following description, an expression in which the application AP is a subject of an operation, such as “application AP . . . ” means that a processor that reads and executes the application AP executes a process using a function of the application AP. For example, the processor is the terminal control unit 26, the browser execution unit 26a, and the like. Similarly, in a case where a process is described using an object as a subject of an operation, such as “object . . . ”, the process means that a processor (corresponding control unit) executes a process using a function of the object. A case where a script that will be described later is described as a subject of an operation, and a case where a program module such as a device driver is described as a subject of an operation are also similar to above-described cases.

In addition, in the browser execution unit 26a, an HTTP client 42 may be operated. The HTTP client 42 establishes a communication path K1 with an HTTP server 61 included in the device control unit 20a. The HTTP client 42 executes a predetermined communication protocol (HTTP) with the HTTP server 61 through the communication path K1, and transmits and receives various data. The communication between the HTTP client 42 and the HTTP server 61 may adopt Websocket communication. For example, the browser execution unit 26a transmits a communication path establishment requirement to the HTTP server 61 by the HTTP client 42 in order to communicate with the control apparatus 11. The HTTP client 42 and the HTTP server 61 cooperate with each other to establish a connection in conformity to the Websocket standard and establish the communication path K1.

The application AP has various functions for the accounting process in the register counter L. For example, the application AP acquires information on a price or the like of a product provided from the POS server 17. In addition, the application AP executes a process related to the accounting of the product, and transmits an execution result to the POS server 17.

In the accounting process executed by the application AP, in a case where the device connected to the control apparatus 11 is operated, the application AP outputs a requirement of the control of the device. Although details will be described later, the application AP requires a start of the control of the device to the control apparatus 11, and makes the device usable. Then, the application AP requires a control for operating the device to the control apparatus 11. In addition, in a case where data obtained by the operation of the device is output from the control apparatus 11, the application AP acquires and processes the data. After the device performs a necessary operation, the application AP requires an end of the control of the device.

In the browser execution unit 26a, the application AP calls a device to be operated, that is, an object corresponding to a device of control target, and the called object performs a process for the control apparatus 11.

The control object 41 transmits data indicating the device of the control target designated by the application AP. The data is transmitted to the device control unit 20a through the HTTP client 42 and the HTTP server 61. For example, a device identifier that is a unique identifier of a device connected to the control apparatus 11 may be used as data designating the device. The device identifier may be a suitably given identifier. In addition, for example, as the device identifier, an OLE for retail POS (OPOS) logical name conforming to a specification of an OPOS standardized in OPOS committee may be used.

In addition, the control object 41 causes the HTTP client 42 to transmit data indicating the operation of the device required by the application AP. In addition, in a case where the control apparatus 11 transmits the data obtained by the operation of the device, the control object 41 receives and acquires the data through the HTTP client 42. The data acquired by the control object 41 is transferred to the application AP and used in the accounting process by the application AP.

As an example of a specific operation of the POS system 1, an outline of the accounting process will be described.

Before a process related to the accounting is performed, the tablet terminal 10 executes each of the following processes. That is, the person in charge of the register counter and a person engaged in other works start the browser of the tablet terminal 10 and instruct a display of a user interface to the touch panel 30. According to the instruction, the browser execution unit 26a of the terminal control unit 26 accesses a predetermined address on the POS server 17, acquires data of a web page such as the HTML file, and displays the user interface on the touch panel 30 based on the data.

The user interface displayed on the touch panel 30 has a display area where a name of a product purchased by a customer, a unit price of a product, and a quantity of a product are listed. In addition, the user interface has a display area where a total amount of money of a product purchased by a customer, an amount of money held by a customer in a case of the accounting, and an amount of change to be given to a customer are displayed. In addition, in the user interface, a field in which information representing the bar code (hereinafter, referred to as “bar code information) read by the bar code scanner 12 is input and displayed is disposed. Basically, the bar code information is identification information uniquely assigned to each kind of product. In addition, in the user interface, a software number pad for a touch input of a numerical value. In addition, in the user interface, a field in which an address of an access destination of the tablet terminal 10 is displayed may be disposed.

In the accounting process, after the bar code is read by the bar code scanner 12, the read barcode information is displayed in the field of the user interface. In this process, since the bar code information is acquired by the application AP, the application AP calls an object that controls the bar code scanner 12 in the control object 41. In the register counter L, the user who is in charge of the register counter operates the bar code scanner 12 and performs an operation of reading a bar code attached to one product purchased by a customer. According to the operation, the bar code information on the read bar code is output to the control object 41 by the control apparatus 11. The control object 41 acquires the bar code information output from the control apparatus 11 and outputs the bar code information to the application AP. The bar code information is displayed in a predetermined field in the user interface and used in the accounting process by the function of the application AP.

In addition, in the accounting process, in a case where the cash changer 13 is operated, the application AP calls an object for controlling the cash changer 13. In response to this, the control object 41 generates a requirement for controlling the cash changer 13 and transmits the requirement to the control apparatus 11, and the control apparatus 11 operates the cash changer 13. In addition, in the accounting process, in a case where a total amount of money or the like is displayed on the display 14, the application AP calls an object for controlling the display 14. In response to this, the control object 41 generates a requirement for controlling the display 14 and outputs the requirement to the control apparatus 11. The control apparatus 11 causes the display 14 to execute the display in response to the requirement generated by the control object 41.

In a case where the application AP causes the printer unit 21 to issue a receipt, the application AP generates an image to be printed on the receipt by the mounted function. The application AP generates an XML document (data) including information on the receipt to be issued by the printer unit 21 based on the generated image. In the XML document, information for issuing the receipt, such as information on a character, or an image to be printed on the receipt, is included in a predetermined format, in conformity to a format related to an XML.

The application AP outputs the device identifier of the printer unit 21, and data including information designating a function executed by the object for controlling the printer, the generated XML document, and the like to the control object 41. In response to this, the control object 41 transmits a requirement to the control apparatus 11 based on the data input from the application AP. In response to the requirement, the control apparatus 11 controls the printer unit 21 to cause the printer unit 21 to execute the print of the receipt, and outputs an execution result to the control object 41. The control object 41 outputs a print result of the receipt to the application AP.

In the operation described above, the control apparatus 11 may output status data indicating operation states of the cash changer 13, the display 14, the printer unit 21, and the like. In this case, the control object 41 acquires the status data output from the control apparatus 11 and transfers the status data to the application AP.

The control object is an object in which various methods related to the device control are mounted, and executes a control of a corresponding device using a function of a corresponding handler. For example, the control object 41 generates a control object that controls the cash changer 13. In the control object, a method of executing a process related to the control of the cash changer 13 is mounted, and the object executes the control of the cash changer 13 using a function of a cash changer handler. A handler refers to a function and a subroutine that executes a process related to a corresponding device in response to a requirement. For example, in a case where the control object 41 generates a control object that controls the bar code scanner 12, the bar code scanner handler receives an input of a reading result in a case where the bar code scanner 12 reads the bar code. In addition, the bar code scanner handler executes an interrupt process and transfers the reading result (for example, data generated by a character string of a number) to the control object of the bar code scanner. Similarly, in a case where other devices are controlled, the control object and the handler function.

In addition, in the control apparatus 11, a device interface 81 that is an interface with the device and each handler cooperate with each other to function as “a second communication unit that communicates with the device”.

The device control unit 20a includes the HTTP server 61, a port control unit 62, a process unit 70, and a device interface 81.

The HTTP server 61 cooperates with the HTTP client 42 of the browser execution unit 26a to execute the communication through the communication path K1. The HTTP server 61 communicates with the HTTP client 42 according to a control of the process unit 70, and outputs a requirement or data received from the HTTP client 42 to the process unit 70. The HTTP server 61 functions as a first communication unit.

The process unit 70 controls a device connected to the device interface 81 according to the requirement received through the HTTP server 61.

The device interface 81 is an interface to which devices including the bar code scanner 12, the cash changer 13, the display 14, and the printer unit 21 are connected. The device interface 81 is shown as one functional block, however, the device interface 81 may include a plurality of interfaces. For example, the device interface 81 may include a USB interface to which the bar code scanner 12 is connected, a serial interface to which each of the cash changer 13 and the display 14 are connected, and the like. In addition, the device interface 81 may include a plurality of interfaces of the same kind, and a specific configuration may be randomly selected.

In addition, in addition to a connector or a signal process circuit as hardware to which each device is connected, the device interface 81 in the drawing shows a function of inputting and outputting a signal to and from each device by such hardware. As described above, the device interface 81 corresponds to the second communication unit in cooperation with a handler that is a function of software or alone.

In the device interface 81, an interface to which the device is connected is distinguished as a port by software. For example, the device interface 81 may have a USB port to which the bar code scanner 12 is connected, a COM port to which the cash changer 13 is connected, and a COM port to which the display 14 is connected. In addition, the device interface 81 may have a USB port to which the printer unit 21 is connected. Each port included in the device interface 81 may be identified by, for example, a number or a symbol given to the port, and it is possible to identify and specify a plurality of ports of same kind.

The port control unit 62 identifies a device connected to the device interface 81 and a port to which each device is connected. In a case where the process unit 70 outputs a command or the like for controlling the device, the port control unit 62 selects a port to which a device of the control target is connected in the device interface 81 and outputs the command or the like to the selected port. The port control unit 62 acquires data output by the device, and outputs the acquired data to the process unit 70 together with data for identifying (specifying) the port by which the data is acquired.

The process unit 70 includes a first device control unit 71 as control means for controlling the device. The first device control unit 71 includes a device control script 72 and a device driver 73. The device control script 72 is a script (program module) that is called and executed in a case where the device is controlled.

The device driver 73 is a driver program for controlling the device, and is a driver corresponding to a specification of the device and the control apparatus 11. The process unit 70 includes a plurality of first device control units 71 for each kind of the device.

For example, in a case where the process unit 70 controls each of the bar code scanner 12, the cash changer 13, the display 14, and the printer unit 21 by the device driver 73, the process unit 70 includes the first device control units 71 corresponding to each of such devices. In this case, the process unit 70 includes the first device control unit 71 having the device driver 73 for controlling the bar code scanner 12. Similarly, the process unit 70 includes the first device control units 71 having the device drivers 73 for controlling the cash changer 13, the display 14, and the printer unit 21. In other words, it is necessary for the process unit 70 to include the device drivers 73 corresponding to the kinds of the devices to be controlled, respectively. In the present embodiment, as described later, at least a part of the bar code scanner 12, the cash changer 13, the display 14, and the printer unit 21 is controlled by a driver 68. Therefore, the process unit 70 includes the first device control unit 71 having the device driver 73 corresponding to the device that is not controlled by the driver 68.

In addition, the process unit 70 may include the first device control unit 71 corresponding to a device that is not connected to the device interface 81. For example, the process unit 70 may include the first device control unit 71 having the device driver 73 that controls a magnetic card reader.

The device driver 73 generates and outputs a command or a parameter suitable for the device based on data output from the device control script 72. The device driver 73 outputs the generated command or parameter to the port selected by the port control unit 62. In a case where the device controlled by the device driver 73 outputs data, the data is transmitted to the device driver 73 that controls a corresponding device by the port control unit 62. The device driver 73 outputs the data output by the device to the device control script 72 in a data format corresponding to a specification of the device control script 72. As described above, the device driver 73 generates and outputs the command or the data (parameter) corresponding to the device, and generates, converts, and outputs the data corresponding to the device control script 72.

The format of the command or the data that is input and output from the device control script 72 is determined in advance as the specification of the control apparatus 11. The device driver 73 is created so as to correspond to the specification of the control apparatus 11. In another expression, the device driver 73 corresponds to a specification of an interface between the device control script 72 and another program. For example, the device driver 73 is created using a Software Development Kit (SDK) provided by a manufacturer manufacturing the control apparatus 11.

In other words, the device driver 73 is a driver program dedicated to the control apparatus 11 that corresponds to the specification of the control apparatus 11. In addition, the device driver 73 is a dedicated driver program corresponding to the kind of the device of the control target. In addition, in many cases, the device driver 73 is a dedicated driver program corresponding to not only the kind of the device but also a model of the device, a manufacturer, or a series (collection of a plurality of models) of the device.

For example, the device driver 73 that controls the bar code scanner 12 corresponds to a command or data format that may be executed and/or processed by the bar code scanner 12 of a specific model. Alternatively, the device driver 73 corresponds to a command or data format that may be executed and/or processed by a plurality of kinds of bar code scanners 12 that are sold by a specific business operator and have a common specification. In addition, the device driver 73 conforms to formats of the command and the data input and output to and from the device control script 72.

A case where the cash changer 13, the display 14, and the printer unit 21 are controlled by the device driver 73 is also similar to the case described above.

On the other hand, the process unit 70 includes a first device control unit 75 different from the first device control unit 71. The first device control unit 75 includes a device control script 76. The device control script 76 is called and started in a case where the first device control unit 75 controls the device. The device control script 76 is a program module for controlling the device using a common communication library 65, a second device control unit 66, a header 67, and a driver 68.

The header 67 and the driver 68 are program modules that control the device, and are driver programs corresponding to the device connected to the control apparatus 11. The driver 68 outputs a command corresponding to the control target device, and acquires the data output by the device. The header 67 calls the driver 68 in response to a requirement of the application AP, and causes the driver 68 to generate a command corresponding to the operation of the device required by the application AP. The driver 68 transmits the command to the device to operate the device. In addition, the driver 68 monitors the status of the device. The header 67 outputs data indicating the status of the device being monitored by the driver 68. In addition, in a case where the device outputs the data, the driver 68 acquires the data and outputs the data to the header 67.

The header 67 is a general purpose program module that is not limited to the specification of the control apparatus 11. For example, the header 67 may be commonly used with respect to devices of the same kind, and has versatility that does not depend on a model, a manufacturer, or the like of a specific device.

For example, the device used in the POS system 1 may be classified into a device class, and the header 67 may be provided as a driver program corresponding to the device class. Specifically, a set of headers 67 may be provided with respect to the bar code scanner 12. In this case, the control apparatus 11 may control a plurality of bar code scanners 12 manufactured by various manufacturers by the set of headers 67. The cases of the cash changers 13, the display 14, and the printer unit 21 are similarly to the case described above. In addition, a case of a class of a device such as a card reader, a cash drawer, and non-contact IC card reader is similar to the case described above. Therefore, a plurality of devices belonging to the same device class may be controlled by one or a few of the headers 67.

Specific examples of the header 67 and the driver 68 include elements conforming to an OPOS specification. This kind of header 67 and driver 68 provide a set of a property, a method, and an event for controlling the device. Here, each word of the property, the method, and the event is used as a meaning used in an object oriented programming.

The header 67 is a Control Object (CO) that provides the set of the property, the method, and the event for each device class. The driver 68 is a Service Object (SO) that is called by the header 67 and executes various functions defined by the OPOS for each device. The driver 68 is called by the header 67 and executes an output of a command for the device or an acquisition of data output by the device. The driver 68 may have a configuration on which an Application Programming Interface (API) is mounted.

The second device control unit 66 is a program module for operating the general purpose header 67, and specifically, is an execution file. The second device control unit 66 calls the header 67 in response to a requirement output by the application AP. The second device control unit 66 converts the requirement output by the application AP into a command or data that may be processed by the header 67, and outputs the command or the data to the header 67. In addition, the second device control unit 66 converts data acquired by the driver 68 into a data format that may be processed by the application AP, and outputs the converted data.

For example, contents of the conversion process executed by the second device control unit 66 may be set by a conversion table 82 (table) described by an XML. For example, the conversion table 82 includes information for defining a data format and the like that may be processed by the header 67 included in the control apparatus 11, and in a case where the control apparatus 11 includes a plurality of headers 67, the conversion table 82 includes information for each second device control unit 66. The second device control unit 66 converts the command or converts the data format according to the setting described in the conversion table 82, by giving the conversion table 82 to the second device control unit 66. Therefore, control information output by the first device control unit 75 may be converted into data that may be processed by the header 67 and a generation or the like of the command may be executed by the header 67. In addition, the data or the like output by the header 67 may be converted by the second device control unit 66 and may be output to the first device control unit 75.

With respect to the application AP, the first device control unit 75 operates similarly to the first device control unit 71, receives the requirement of the application AP, and outputs data to the application AP. The first device control unit 75 includes the device control script 76 for controlling the device by the second device control unit 66. The device control script 76 calls the second device control unit 66 to cause the second device control unit 66 to execute, in response to the requirement of the application AP.

The common communication library 65 (communication module) relays communication between the first device control unit 75 and the second device control unit 66. The common communication library 65 is a library for executing communication between processes of the process unit 70 and the second device control unit 66, and is configured of, for example, a Dynamic Link Library (DLL). The common communication library 65 is a library obtained by modularizing a communication procedure between the first device control unit 75 and the second device control unit 66. The common communication library 65 functions as a wrapper of the second device control unit 66, and executes communication between processes by a socket between the process unit 70 and the second device control unit 66.

The common communication library 65 executes socket communication with the first device control unit 75, and receives information output by the first device control unit 75 based on information transmitted by the tablet terminal 10. The common communication library 65 transmits information to the second device control unit 66 based on the received information. The information transmitted by the common communication library 65 corresponds to second device control information.

The common communication library 65 is used by a plurality of second device control units 66. That is, in a case where the control apparatus 11 includes the plurality of second device control units 66 corresponding to different device classes, the plurality of second device control units 66 communicate with the first device control unit 75 through the common communication library 65. A communication procedure between the second device control unit 66 and the first device control unit 75 may be common using the common communication library 65. Therefore, it is not necessary for each second device control unit 66 to mount the communication procedure with the first device control unit 75, and there is an effect that the mount of the second device control unit 66 may be easier.

The process unit 70 manages the first device control unit 71 and the second device control unit 66 by a device control unit management table 22a stored in the storage unit 22. In addition, the process unit 70 manages the tablet terminal 10 that requires the control of the device, the device of the control target, and a port to which the device of the control target is connected by a device communication management table 22b (device communication management information) stored in the storage unit 22.

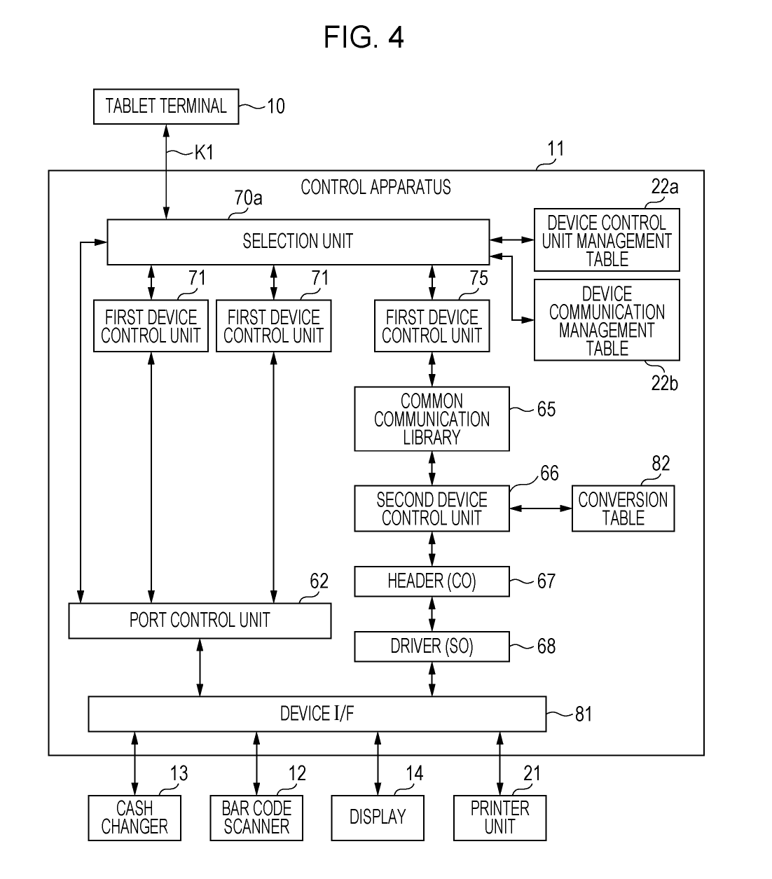

FIG. 4 is a schematic diagram showing an operation of the control apparatus 11, and especially, shows an operation of the device control unit 20a.

The process unit 70 (FIG. 3) includes a selection unit 70a. The selection unit 70a is a block configuring a part of the function of the process unit 70, and communicates with the tablet terminal 10 by the HTTP server 61 (FIG. 3).

In a case where the tablet terminal 10 requires the control, the selection unit 70a specifies the device of the control target based on the device identifier transmitted by the tablet terminal 10. The selection unit 70a selects a device control unit to be used for the control between the first device control unit 71 and the second device control unit 66 corresponding to the identified device.

In the following description, in a case where the first device control unit 71 and the second device control unit 66 are not distinguished from each other and are collectively referred, the first device control unit 71 and the second device control unit 66 are described as a “device control unit”.

In a case where the selection unit 70a selects the first device control unit 71, the selection unit 70a calls the device control script 72 (FIG. 3) of the first device control unit 71. The called device control script 72 communicates with the port control unit 62 to specify the port to which the device of the control target is connected, and returns a specified result to the selection unit 70a as a return value. The selection unit 70a communicates with the port control unit 62 based on the return value of the first device control unit 71 to control the device connected to the device interface 81.

In addition, in a case where the selection unit 70a selects the second device control unit 66, the selection unit 70a calls the device control script 76 (FIG. 3) of the first device control unit 75 corresponding to the second device control unit 66. The device control script 76 outputs information for controlling the device of the control target to the second device control unit 66.

As described above, in order to manage the first device control unit 71 and the second device control unit 66, the selection unit 70a uses the device control unit management table 22a (device control management information).

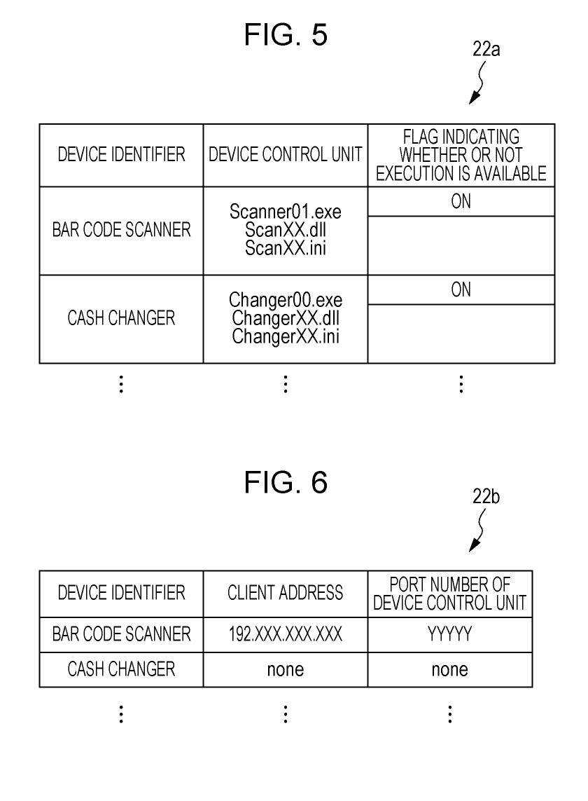

FIG. 5 is a schematic diagram showing a configuration example of the device control unit management table 22a.

As shown in FIG. 5, the device control unit management table 22a associates the device identifier with a file configuring the device control unit corresponding to the device identifier.

In the device control unit management table 22a, a plurality of unique device identifiers may be set, and a plurality of device control units may be registered with respect to one device identifier. The device control unit may include one or more executable programs, and, for example, may include a plurality of executable programs. In this case a program to be first started among the programs configuring the device control unit is designated by the device control unit management table 22a. Specifically, in the device control unit management table 22a, a path of an execution file that is the program configuring the device control unit is included.

The device control unit management table 22a may have a configuration that may register a program library or a setting file as the device control unit. For example, in a case where a program functioning as the device control unit is executed, the program may copy a setting file or a file of a secondary executed program to a predetermined storage area to execute the setting file or the file of the program. In such a case, there is an advantage that a necessary file may be quickly processed by registering the setting file or the secondary executed program in the device control unit management table 22a as the device control unit. In a case where the program configuring the device control unit, that is, the execution file does not copy the setting file or the like, only an absolute path of the program (execution file) that is first called may be registered in the device control unit management table 22a.

In a case where the control of the device is required by the application AP, the selection unit 70a specifies a file corresponding to the device identifier of the device of the control target by the device control unit management table 22a, and executes the designated file. Therefore, the device control unit corresponding to the device specified by the application AP may be immediately started.

In addition, the device control unit management table 22a has a flag that indicates whether or not the execution file configuring each device control unit is available. That is, the device control unit installed in the control apparatus 11 may be set so as not to be executed by the device control unit management table 22a.

FIG. 6 is a schematic diagram showing a configuration example of the device communication management table 22b.

The device communication management table 22b is a table for managing a communication destination of a case where the device is controlled by the device control unit. The device communication management table 22b stores the device identifier of the device of the control target and an address (for example, an IP address) of the tablet terminal 10 that requires the control of the device in association with each other. The tablet terminal 10 that requires the control of the device means the tablet terminal 10 that executes the application AP. In addition, the device communication management table 22b stores a response port number (a response port of the socket communication) of the device control unit in association with the device identifier. The address (a client address) of the tablet terminal 10 set in the device communication management table 22b may specify the tablet terminal 10, and is not limited to the IP address.

Information of the device communication management table 22b is registered in a case where the control of the device is started, and is deleted in a case where the control of the device is ended. Therefore, the device corresponding to the device identifier registered in the device communication management table 22b is controlled by the tablet terminal 10. Therefore, although another tablet terminal 10 requires the control of the corresponding device, the selection unit 70a does not execute the requirement. Thus, duplication of a control for one device may be prevented.

The first device control unit 71 and the second device control unit 66 are not always executed, and the selection unit 70a selects and starts the first device control unit 71 or the second device control unit 66 according to the requirement of the application AP. Therefore, resources of the control apparatus 11 such as a processor or a memory configuring the process unit 70 may be efficiently used.

Although details will be described later, information registered in the device control unit management table 22a shown in FIG. 5 is added, updated, or deleted by a function of the selection unit 70a. In addition, the control apparatus 11 may add, update, or delete the information registered in the device control unit management table 22a based on management information transmitted by the tablet terminal 10. In this case, the tablet terminal 10 transmits the management information including the processes (addition, update, deletion, and the like) for the device control unit management table 22a and information to be processed to the control apparatus 11. The process unit 70 performs the processes on the device control unit management table 22a stored in the storage unit 22 according to the management information transmitted by the tablet terminal 10, and updates the device control unit management table 22a.

A case of the device communication management table 22b shown in FIG. 6 is similar to the case described above. Although details will be described later, information registered in the device communication management table 22b is added, updated, or deleted by the function of the selection unit 70a. The control apparatus 11 may add, update, or delete the information registered in the device communication management table 22b based on the management information transmitted by the tablet terminal 10. In this case, the tablet terminal 10 transmits the management information including the processes (addition, update, deletion, and the like) for the device communication management table 22b and information to be processed to the control apparatus 11. The process unit 70 performs the processes on the device communication management table 22b stored in the storage unit 22 according to the management information transmitted by the tablet terminal 10, and updates the device communication management table 22b.

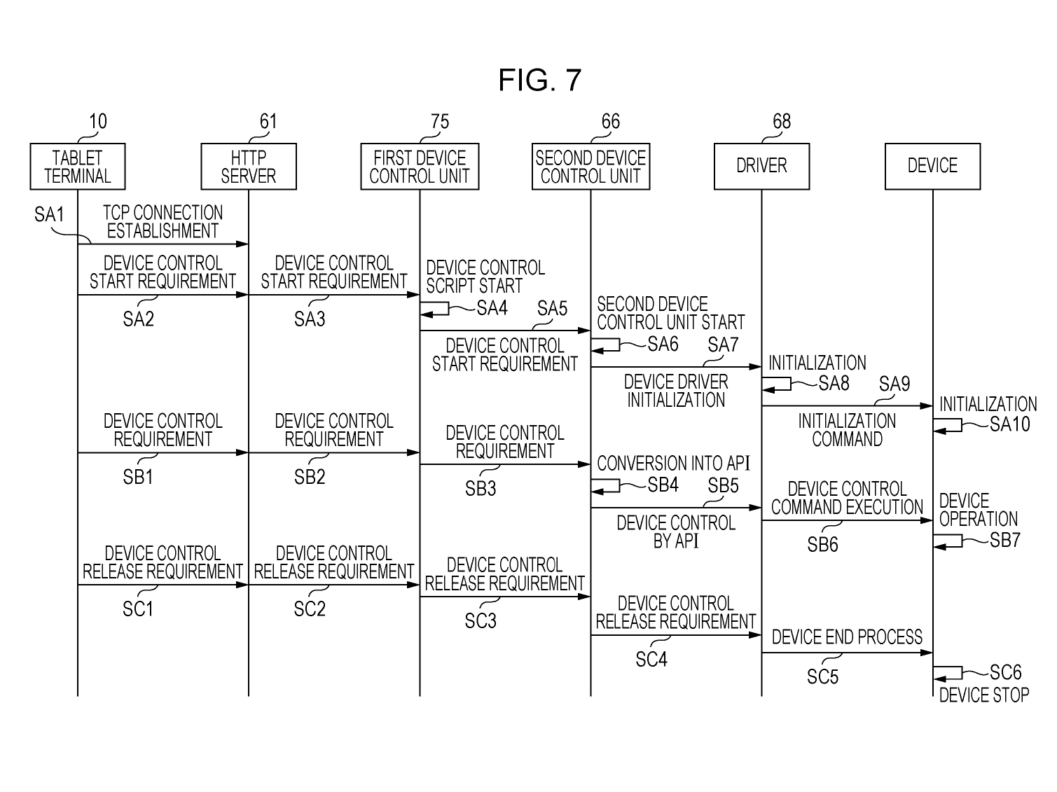

FIG. 7 is a sequence diagram showing the operation of the POS system 1. In FIG. 7, the device of the control target connected to the control apparatus 11 is referred to as a “device”. Specifically, the “device” of FIG. 7 is one of the bar code scanner 12, the cash changer 13, the display 14, and the printer unit 21.

FIG. 7 shows an operation in a case where the device of which the control is required by the tablet terminal 10 is the device controlled by the second device control unit 66. That is, FIG. 7 shows an operation in a case where the selection unit 70a selects the second device control unit 66 as the device control unit corresponding to the device.

The tablet terminal 10 establishes TCP communication with the HTTP server 61 by a function of the HTTP client 42 (step SA1). The process of step SA1 may include a step of forming the communication path K1 between the tablet terminal 10 and the control apparatus 11. Alternatively, the process of step SA1 may be a process of establishing a connection in the TCP in the formed communication path K1.

The tablet terminal 10 executes the application AP according to the operation of the user, and performs the accounting process. In this process, the tablet terminal 10 transmits a device control start requirement for starting the control of the device connected to the control apparatus 11 to the control apparatus 11 (step SA2.) The device control start requirement is a message for requiring the start of the control for one of the bar code scanner 12, the cash changer 13, the display 14, and the printer unit 21 to the control apparatus 11. The device control start requirement includes the device identifier that designates the device of the control target.

The HTTP server 61 receives and transmits the device control start requirement transmitted by the tablet terminal 10 (step SA3). A transmission destination to which the HTTP server 61 transmits the device control start requirement is selected based on the device identifier included in the device control start requirement by the selection unit 70a. The selection unit 70a selects the first device control unit 71 or the second device control unit 66 corresponding to the device identifier. In a case where the selection unit 70a selects the second device control unit 66 corresponding to the device identifier, the selection unit 70a selects the first device control unit 75 communicating with the second device control unit 66 as the communication destination of the HTTP server 61. In the operation example of FIG. 7, the first device control unit 75 is selected by the selection unit 70a, and the device control start requirement is transmitted from the HTTP server 61 to the first device control unit 75.

The first device control unit 75 starts the device control script 76 (step SA4), and transmits the device control start requirement to the second device control unit 66 by the function of the device control script 76 (step SA5). The second device control unit 66 performs the start according to the device control start requirement transmitted from the device control script 76 (step SA6), calls the driver 68 through the header 67, and initializes the driver 68 (step SA7). Therefore, the driver 68 is initialized (step SA8), and an initialization command for initializing the device of the control target by the driver 68 is transmitted to the device (step SA9). The device of the control target is initialized based on the initialization command (step SA10), and the device of the control target may be controlled by the control apparatus 11.

In the series of the operations of steps SA2 to SA10, the driver 68 may detect that the initialization of the device is completed, and the driver 68 may transmit a notification of the initialization completion of the device to the second device control unit 66. In this case, the second device control unit 66 may notify the first device control unit 75 that the control start of the device is completed, and the first device control unit 75 may transmit the notification to the tablet terminal 10 through the HTTP server 61.

Next, the tablet terminal 10 transmits a device control requirement according to necessity of the operation of the device (step SB1). The device control requirement includes the device identifier of the device of the control target and data specifying contents of the operation to be executed in the device.

The HTTP server 61 receives and transmits the device control requirement transmitted by the tablet terminal 10 (step SB2). The transmission destination to which the HTTP server 61 transmits the device control requirement is a transmission destination selected by the selection unit 70a in step SA2 and SA3 corresponding to the device identifier. In the operation example of FIG. 7, the device control requirement is transmitted from the HTTP server 61 to the first device control unit 75.

The first device control unit 75 transmits the device control requirement to the second device control unit 66 by the device control script 76 started in step SA4 (step SB3). The second device control unit 66 converts data included in the device control requirement into data to be transferred to the API of the driver 68 (step SB4). The second device control unit 66 transfers data indicating contents for controlling the device to the API of the driver 68 (step SB5).

The driver 68 generates a command for operating the device to cause the device to execute the command (step SB6), and therefore, the device executes the operation required by the application AP (step SB7).

In the series of the operations of step SB1 to SB7, the driver 68 may monitor the device, and a completion of the operation of the device may be notified from the driver 68 to the second device control unit 66 as the status of the device. In this case, the second device control unit 66 may notify the first device control unit 75 that the operation of the device is completed, and the first device control unit 75 may transmit the notification to the tablet terminal 10.

In a case where the tablet terminal 10 does not use the device (for example, in a case where the application AP of the accounting process is ended), in order to end the control of the device, the tablet terminal 10 transmits a device control release requirement (step SC1). The HTTP server 61 transmits the device control release requirement (step SC2). In the example of FIG. 7, the device control release requirement is transmitted to the first device control unit 75 selected by the selection unit 70a.

The first device control unit 75 transmits the device control release requirement to the second device control unit 66 (step SC3), and the second device control unit 66 requires the release of the device control to the driver 68 (step SC4). Therefore, the driver 68 performs a process of ending the control of the device (step SC5), and the device stops the operation (step SC6).

In the series of the operations of steps SC1 to SC6, the driver 68 may monitor the device, and the driver 68 may notify the second device control unit 66 of the stop of the device as the status of the device. In this case, the second device control unit 66 may notify the first device control unit 75 that the control of the device is released, and the first device control unit 75 may transmit the notification to the tablet terminal 10.

Next, operations of registering (installing) and deleting the device control unit in the control apparatus 11, an operation of using the device control unit, and the like will be described.

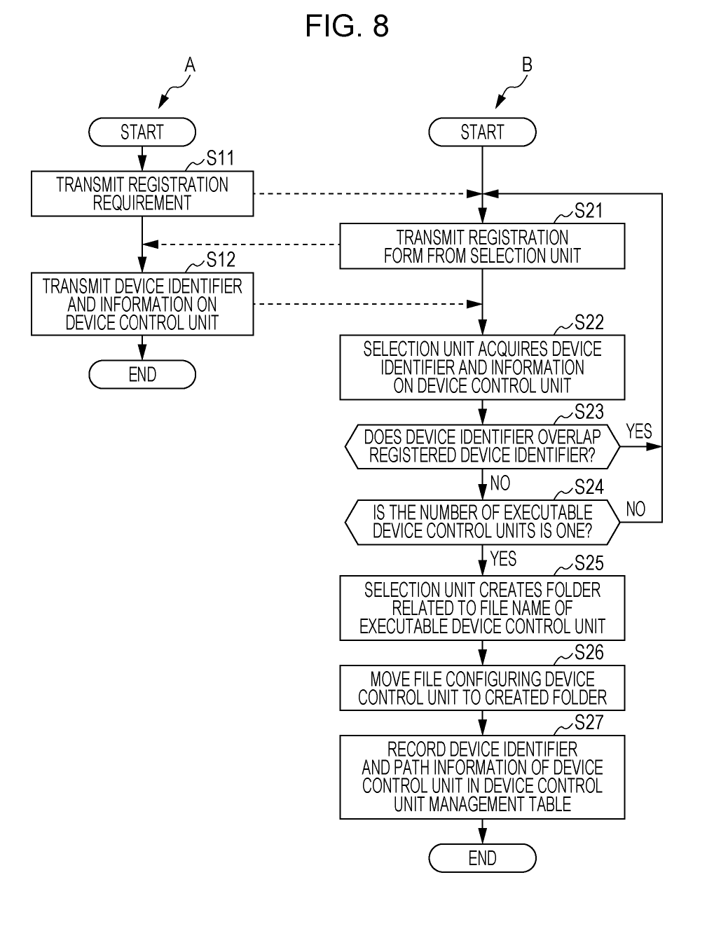

FIG. 8 is a flowchart of the operation of the POS system 1, and shows the operation of registering the device control unit in the control apparatus 11. A reference symbol A of FIG. 8 indicates the operation of the tablet terminal 10, and a reference symbol B indicates the operation of the control apparatus 11.

In a case where the tablet terminal 10 transmits a registration requirement for requiring a registration of the device control unit to the control apparatus 11 (step S11), the control apparatus 11 receives the registration requirement and transmits a registration form from the selection unit 70a to the tablet terminal 10 (step S21). The registration form is a template for transmitting information necessary for the registration, the tablet terminal 10 displays an input user interface based on the registration form, and thus the user may easily input information. The information necessary for the registration includes the device identifier of the device controlled by the device control unit to be registered, and a path of the file configuring the device control unit.

The tablet terminal 10 transmits the information input based on the registration form to the control apparatus 11 (step S12). The control apparatus 11 receives the information transmitted from the tablet terminal 10, and acquires the received information by the selection unit 70a (step S22). The selection unit 70a determines whether or not the information acquired in step S22 overlaps a registered device control unit (step S23). In step S23, the selection unit 70a determines whether or not the information overlaps the registered device control unit by referring to, for example, the device control unit management table 22a. For example, the selection unit 70a performs the determination based on whether or not information such as a file name or a path acquired in step S22 corresponds to information registered in the device control unit management table 22a.

In a case where it is determined that the information overlaps the registered device control unit (step S23; Yes), the selection unit 70a returns to step S21.

In a case where it is determined that the information does not overlap the registered device control unit (step S23; No), the selection unit 70a determines whether or not the number of the executable device control units is one corresponding to the acquired device identifier (step S24). For example, in step S24, the selection unit 70a performs the determination by referring to the device identifier corresponding to the device control unit of which an executable flag is set to ON in the device control unit management table 22a.

In a case where the number of the device control units corresponding to the device identifier is not one (step S24; No), the selection unit 70a returns to step S21. Therefore, a situation where a plurality of device control units are registered corresponding to one device identifier may be prevented.

In a case where the number of the device control units corresponding to the device identifier is one (step S24; Yes), the selection unit 70a creates a folder for storing the file configuring the device control unit in the storage unit 22 (step S25). A folder name or the like related to the file name of the file or the path acquired in step S22 is given to the folder created in step S25.

Next, the selection unit 70a moves the file configuring the device control unit to the folder created in step S25 (step S26). The selection unit 70a registers information on the registered device control unit in the device control unit management table 22a (step S27). That is, the selection unit 70a registers the device identifier and the information on the file configuring the device control unit in the device control unit management table 22a. In addition, in step S27, the executable flag of the device control unit may be set to ON.

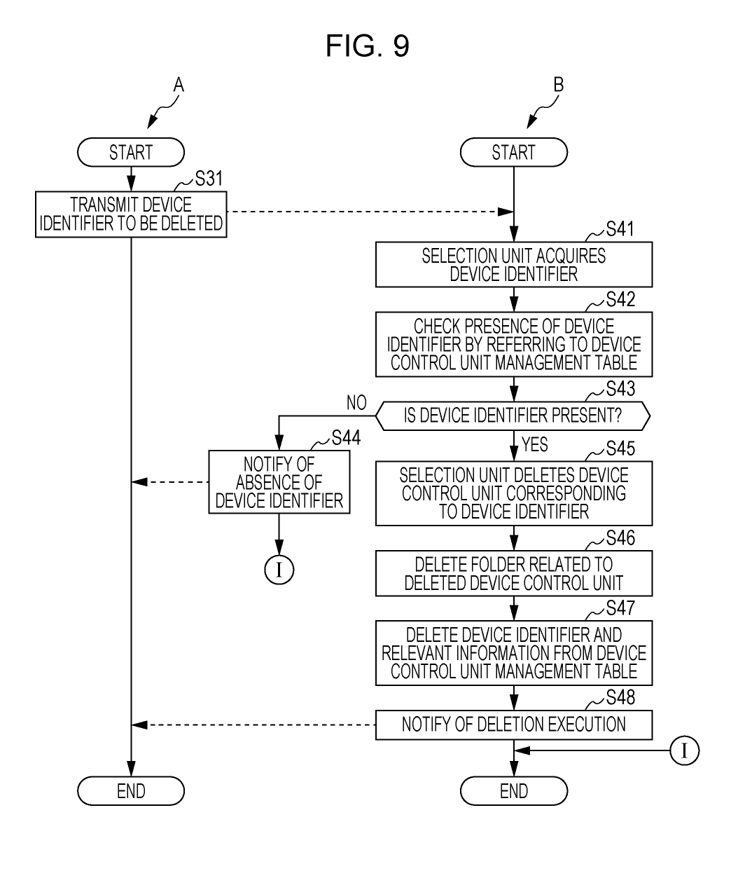

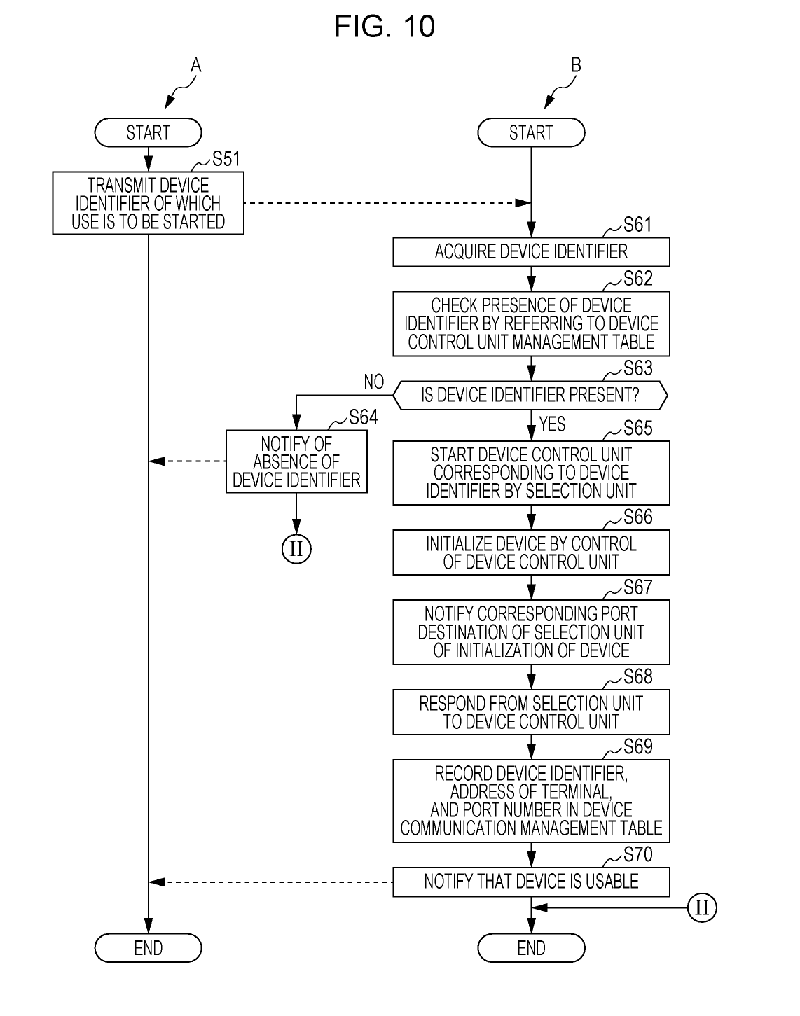

FIG. 9 is a flowchart showing the operation of the POS system 1, and shows the operation of deleting the device control unit from the control apparatus 11. In FIG. 9, a reference symbol A indicates the operation of the tablet terminal 10, and a reference symbol B indicates the operation of the control apparatus 11.

In a case where the tablet terminal 10 transmits the device identifier corresponding to the device control unit to be deleted to the control apparatus 11 (step S31), the control apparatus 11 receives the device identifier and acquires the device identifier by the selection unit 70a (step S41). The selection unit 70a checks that the device identifier acquired in step S41 is registered in the device control unit management table 22a (step S42).

In a case where the device identifier acquired in step S41 is not registered in the device control unit management table 22a (step S43; No), the selection unit 70a notifies the tablet terminal 10 of an absence of the device identifier (step S44), and ends the present process.

In a case where the device identifier is registered in the device control unit management table 22a (step S43; Yes), the selection unit 70a deletes the device control unit registered in the device control unit management table 22a corresponding to the device identifier of a target (step S45). In step S45, the file configuring the device control unit is deleted.

Next, the selection unit 70a deletes the folder storing the file of the device control unit corresponding to the device identifier of the target from the storage unit 22 (step S46). In addition, the selection unit 70a deletes information on the device identifier of the target, the file name or the path of the device control unit, and the like from the device control unit management table 22a (step S47). In step S47, the selection unit 70a may delete various information registered in the device control unit management table 22a corresponding to the device identifier, such as the executable flag. The selection unit 70a notifies the tablet terminal 10 of a performance of the deletion (step S48), and ends the present process.

In the operations shown in FIG. 8 and FIG. 9, a configuration in which a program or a data file configuring the device control unit is transmitted (uploaded) from the tablet terminal 10 to the control apparatus 11 and registered in the control apparatus 11 is exemplified. In this method, in a case where the device control unit is registered in the operation of FIG. 8, the control apparatus 11 acquires the file and stores the file in the storage unit 22.

In addition to the configuration described above, an aspect of the POS system 1 may include a configuration in which the file configuring the device control unit is stored in the storage unit 22 in advance, and the device control unit is registered using the file stored in advance.

In this case, in the operation of FIG. 8, the processes of steps S25 and S26 are omitted. In addition, in step S12 of FIG. 8, the tablet terminal 10 transmits the information on the path of the file configuring the device control unit, and the like, and does not transmit the file. In addition, in the operation of FIG. 9, the process of step S46 is omitted. In this configuration, the registration and the deletion of the device control unit may be performed without moving the file configuring the device control unit. In addition, although the device control unit is deleted, since the file configuring the device control unit is stored in the storage unit 22, a process of registering the deleted device control unit again is easy.

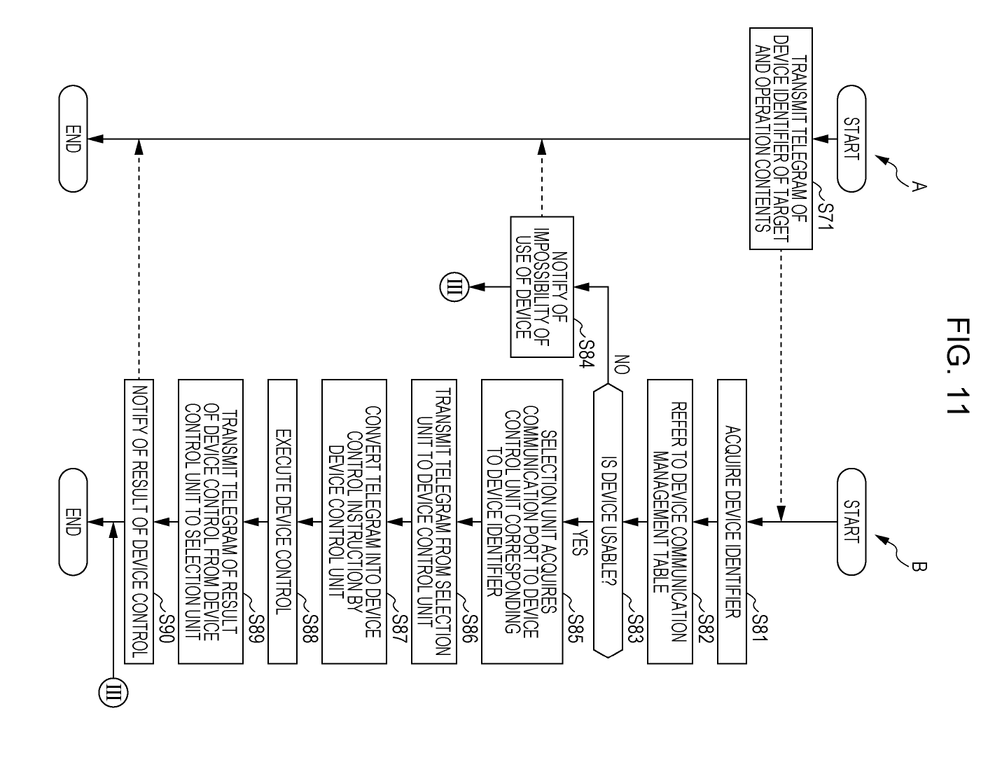

FIG. 10 is a flowchart showing the operation of the POS system 1, and shows the operation of starting a use of the device of the control apparatus 11. In FIG. 10, a reference symbol A indicates the operation of the tablet terminal 10, and a reference symbol B indicates the operation of the control apparatus 11.

In a case where the tablet terminal 10 transmits the device identifier to be used to the control apparatus 11 based on the operation of the application AP (step S51), the control apparatus 11 receives the device identifier and acquires the device identifier by the selection unit 70a (step S61). The selection unit 70a checks that the device identifier acquired in step S61 is registered in the device control unit management table 22a (step S62).

In a case where the device identifier acquired in step S61 is not registered in the device control unit management table 22a (step S63; No), the selection unit 70a notifies the tablet terminal 10 of an absence of the device identifier (step S64), and ends the present process.

In a case where the device identifier is registered in the device control unit management table 22a (step S63; Yes), the selection unit 70a starts the device control unit registered in the device control unit management table 22a corresponding to the device identifier of a target (step S65). Here, in a case where the selection unit 70a starts the device control unit, a factor may be given to the selection unit 70a. For example, in a case where the selection unit 70a communicates with a plurality of device control units, information for identifying the device control units (for example, a port number of the socket communication) may be given to the selection unit 70a. In addition, in a case where one device control unit controls a plurality of different devices, in step S65, information for identifying the devices (device identifier or the like) may be given to the selection unit 70a as the factor. According to such configurations, the selection unit 70a may specify the device of the control target and the device control unit that controls the device among the plurality of device control units or the plurality of devices.

The selection unit 70a initializes the device by a function of the started device control unit (step S66). In a case where the initialization of the device is completed, the device control unit (for example, the second device control unit 66) notifies the completion of the initialization (step S67). In step S67, the notification is performed to a port by which the selection unit 70a communicates with the device control unit. For example, in a case where the initialization of the device is completed, the device control unit may execute communication with the selection unit 70a within a predetermined time from the completion of the initialization, and the execution of the communication may be regarded as the notification of the completion of the initialization. In this configuration, for example, the completion of the initialization of the device may be notified by performing the process of initializing the common communication library 65. Therefore, it is not necessary to transmit a telegram indicating the completion of the initialization of the device to the selection unit 70a, and the procedure may be simplified.

After the selection unit 70a receives the notification of the completion of the initialization, the selection unit 70a performs response communication with the device control unit (step S68), and registers information in the device communication management table 22b (step S69). In step S69, for example, the device identifier acquired in the step S61, the address of the tablet terminal 10 with which the started device control unit communicates, and the port number are registered in the device communication management table 22b.

In addition, the selection unit 70a notifies the tablet terminal 10 that the device corresponding to the device identifier transmitted in step S51 is usable device (step S70), and ends the present process.

FIG. 11 is a flowchart showing the operation of the POS system 1, and shows the operation of using the device control unit of the control apparatus 11. In FIG. 11, a reference symbol A indicates the operation of the tablet terminal 10, and a reference symbol B indicates the operation of the control apparatus 11.

The tablet terminal 10 transmits a telegram including the device identifier of the control target, and information indicating contents of an operation to be executed in the device to the control apparatus 11, based on the operation of the application AP (step S71). For example, the telegram transmitted in step S71 is data of an XML format transmitted and received between the HTTP client 42 and the HTTP server 61.

The control apparatus 11 receives the device identifier, and acquires the device identifier by the selection unit 70a (step S81). The selection unit 70a checks that the device identifier acquired in the step S81 is registered in the device communication management table 22b (step S82).

In a case where the device identifier acquired in step S81 is not registered in the device communication management table 22b (step S83; No), the selection unit 70a notifies the tablet terminal 10 that the device is not usable (step S84), and ends the present process.

In a case where the device identifier acquired in step S81 is registered in the device communication management table 22b (step S83; Yes), the selection unit 70a acquires a communication port of the device control unit (step S85). Specifically, the selection unit 70a acquires information on the communication port of the device control unit registered in the device control unit management table 22a corresponding to the device identifier of the target.

The selection unit 70a transmits the telegram received in step S81 to the acquired communication port (step S86). The device control unit converts the telegram transmitted from the selection unit 70a into a device control instruction for controlling the device (step S87). In addition, according to the converted device control instruction, the device driver 73 or the driver 68 generates a command corresponding to the device, and controls the device (step S88).

The device control unit detects or acquires a result of the control of the device, generates a telegram indicating the result of the control, and transmits the telegram to the selection unit 70a (step S89). The selection unit 70a notifies the tablet terminal 10 of the result of the control of the device (step S90), and ends the present process.

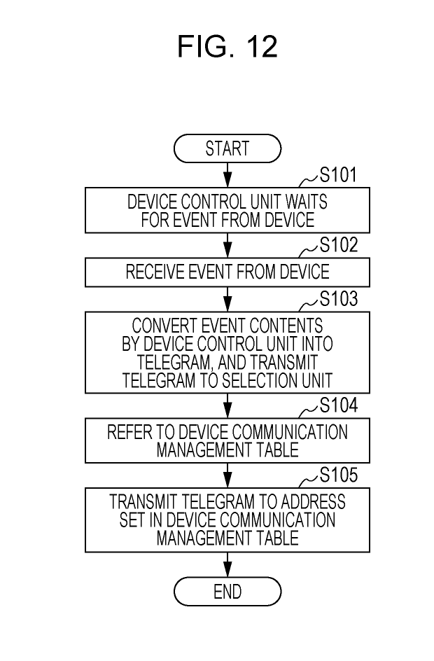

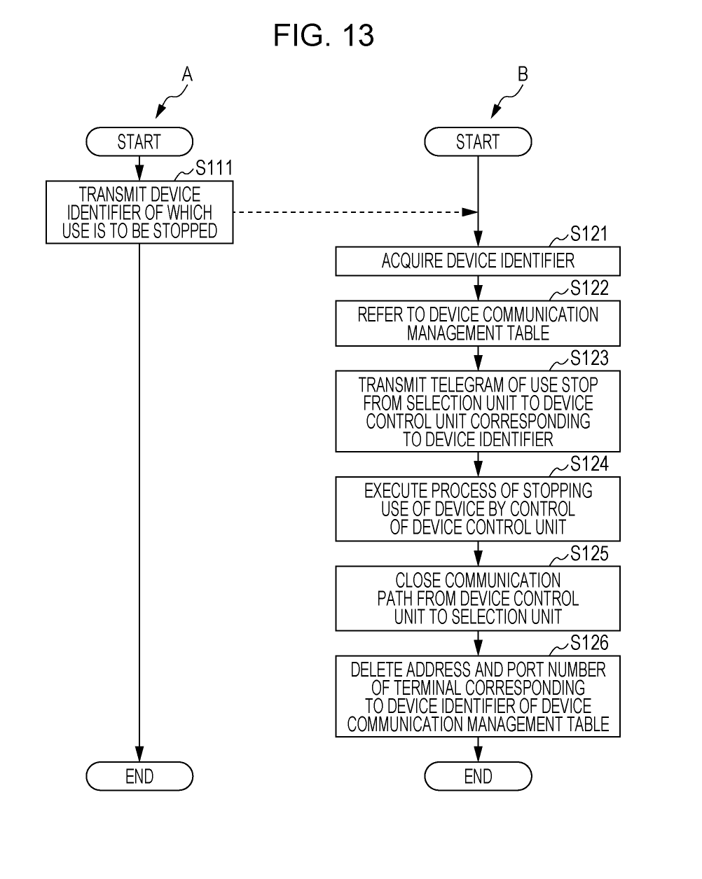

FIG. 12 is a flowchart showing the operation of the control apparatus 11. Especially, FIG. 12 shows an operation in which the control apparatus 11 detects an event of the device.

The operation of FIG. 12 is executed by the device control unit started by the selection unit 70a. The device control unit is started by the operation shown in FIG. 10, and after initializing the device of the control target, the device control unit waits for the event of the device (step S101). In a case where the device control unit receives the event generated in the device (step S102), the device control unit converts event contents into a telegram readable by the selection unit 70a and transmits the telegram to the selection unit 70a (step S103). The selection unit 70a refers to the device communication management table 22b (step S104), and transmits the telegram to the address of the tablet terminal 10 set in the device communication management table 22b (step S105). Therefore, in a case where an event occurs in a usable device, the event contents may be notified to the tablet terminal 10.

FIG. 13 is a flowchart showing the operation of the POS system 1, and shows the operation of stopping a use of the device of the control apparatus 11. In FIG. 13, a reference symbol A indicates the operation of the tablet terminal 10, and a reference symbol B indicates the operation of the control apparatus 11.

In a case where the tablet terminal 10 transmits the device identifier of which the use is to be stopped to the control apparatus 11 based on the operation of the application AP (step S111), the control apparatus 11 receives the device identifier and acquires the device identifier by the selection unit 70a (step S121). The selection unit 70a refers to the device communication management table 22b based on the device identifier acquired in step S121 (step S122).

The selection unit 70a transmits a telegram instructing the use stop to the device control unit corresponding to the device identifier acquired in step S121 (step S123).

The device control unit controls the device to perform a process of stopping the use (step S124), and performs a process of closing a communication path for communicating from the device control unit to the selection unit 70a (step S125). Here, the device control unit may disconnect the communication between the device control unit and the selection unit 70a regardless of a result of the process of stopping the use of the device. Specifically, in a case where the common communication library 65 receives a notification indicating the use stop of the device from the device control unit, the common communication library 65 may be realized by a specification for disconnecting the communication with the device selection unit.

The selection unit 70a deletes the information registered corresponding to the device identifier of which the use is stopped in the device communication management table 22b (step S126). For example, the selection unit 70a deletes an address of a path registered in the device communication management table 22b corresponding to the device identifier of the target.

As described above, the control apparatus 11 enables a general purpose device driver such as the header 67 and the driver 68 to be usable by the second device control unit 66. Therefore, in a case where a device of which a device driver program is opened to the control apparatus 11, the device may be quickly used, and for example, time and effort for preparing the dedicated device driver 73 according to a specification of the device may be omitted. In addition, even a device of which a specification for creating the device driver 73 is not opened may be used by connecting the device to the control apparatus 11.

In addition, in a case where the control apparatus 11 uses the second device control unit 66 suitable for a general purpose API specification, a device suitable for the general purpose API specification may be controlled. For example, in a case where the second device control unit 66 has a configuration corresponding to an OPOS bar code scanner API, a bar code scanner provided from another manufacturer (vendor) may be used by the OPOS bar code scanner API. That is, both a bar code scanner “A” manufactured or sold by a manufacturer A and a bar code scanner “B” manufactured or sold by a manufacturer B may be controlled by the second device control unit 66 and the OPOS bar code scanner API. In addition, since the device that may be controlled by the control apparatus 11 does not depend on an interface of the device, there are advantages that a method of connecting the device to the control apparatus 11 is not limited and various devices may be used.

As described above, the control apparatus 11 according to the embodiment to which the invention is applied includes the HTTP server 61 as the first communication unit that communicates with the tablet terminal 10, and the device interface 81 as the second communication unit that communicates with the device. The control apparatus 11 includes the first device control unit 71 on which the first control module corresponding to the device is mounted, and the second device control unit 66 that uses the second control module that is able to correspond to the device. The first control module is, for example, the device driver 73, and the second control module is, for example, the driver 68 or a combination of the header 67 and the driver 68. The control apparatus 11 includes the process unit 70 that selects the first device control unit 71 or the second device control unit 66 based on the control information received from the tablet terminal 10 by the HTTP server 61. The process unit 70 generates the command based on the control information, and transmits the generated command to the device through the device interface 81.

The control information transmitted by the tablet terminal 10 includes the device identifier indicating the device of the control target. In addition, the control information may include any of the control start requirement, the control end requirement, the control contents for the device that is specified by the device identifier, and the like.

According to the configuration to which the device control apparatus and the method of controlling the device control apparatus of the invention are applied, in a case where the device is controlled, the first device control unit 71 on which the first control module is mounted and the second device control unit 66 using the second control module may be selected. As described above with respect to the device driver 73, the first control module is a control module corresponding to the device, and is a so-called dedicated control program corresponding to a model, a kind, a manufacturer, and the like of the device. On the other hand, the second control module is a control module that is able to correspond to the device, and may be a general purpose program capable of controlling a device of a plurality of models or a plurality of kinds including the device. For example, the second control module may be a known general purpose control module provided corresponding to the device class.

Therefore, in order to control the device, for example, the second control module that is a general purpose program module, and the first control module may be used. As long as it is possible to mount the general purpose second control module that may be easily obtained, in a case where the dedicated first control module is not able to be operated due to development or the like, the dedicated first control module may not be mounted. Thus, it is possible to reduce a burden of procuring the control module corresponding to the device and it is possible to use various devices.

The control apparatus 11 includes the storage unit 22 that stores the device control unit management table 22a indicating the correspondence between the device identifier for identifying the device and the first device control unit 71 or the second device control unit 66. The process unit 70 selects the first device control unit 71 or the second device control unit 66 by referring to the device control unit management table 22a of the storage unit 22 based on the device identifier included in the control information received from the tablet terminal 10. The process unit 70 transmits the command to the device designated by the device identifier included in the control information by the selected device control unit. According to the configuration, the first device control unit 71 on which the first control module is mounted and the second device control unit 66 using the second control module may be suitably selected corresponding to the device, based on the device control unit management table 22a.

The storage unit 22 has the device communication management table 22b indicating the correspondence between the device identifier and the tablet terminal 10. The process unit 70 determines whether or not the device designated by the device identifier included in the control information is able to execute communication, by referring to the device communication management table 22b of the storage unit 22, based on the device identifier included in the control information received from the tablet terminal 10. In a case where the process unit 70 determines that the device is able to execute the communication, the process unit 70 selects the first device control unit 71 or the second device control unit 66. According to the configuration, in a case where the device designated by the tablet terminal 10 is able to execute the communication, since the command is transmitted by selecting the first device control unit 71 or the second device control unit 66, it is possible to improve an efficiency of the control of the device.

The process unit 70 may execute at least one of the addition, the update, and the deletion of the device control unit management table 22a and/or the device communication management table 22b, based on the management information received from the tablet terminal 10 by the HTTP server 61. According to the configuration, since the addition, the update, the deletion, and the like of information on the device of the control target are possible, it is possible to efficiently control the device.

The process unit 70 includes the selection unit 70a that selects the first device control unit 71 and the second device control unit 66. In addition, the process unit 70 includes the port control unit 62 as the first process unit that transmits the command to the device based on a process result of the first control module mounted on the first device control unit 71, in a case where the first device control unit 71 is selected by the selection unit 70a. In addition, the process unit 70 includes the common communication library 65 that transmits the second device control information to the second device control unit 66 based on the control information received from the tablet terminal 10, in a case where the second device control unit 66 is selected by the selection unit 70a. The second device control unit 66 generates the control data corresponding to the second control module based on the second device control information received from the common communication library 65. According to the configuration, since the second device control unit 66 receives the second device control information through the communication module, although the specification of the second control module is different from that of the first control module, it is possible to securely cause the second control module to function.

The control apparatus 11 has the conversion table 82 that defines the control data for each driver 68. The second device control unit 66 converts the second device control information received from the common communication library 65 into the control data corresponding to the driver 68, by referring to the conversion table 82. According to the configuration, it is possible to convert the control data into corresponding data, for each of the plurality of second control modules. Therefore, it is possible to cause the second control modules of various specifications to function, and it is possible to control various devices.

The driver 68 as the second control module generates the command unique to the device based on the control data input from the second device control unit 66. According to the configuration, since it is possible to control a device that requires the unique command, it is possible to use wider variety of devices.

In addition, since the common communication library 65 is configured as a wrapper that relays the communication between the process unit 70 and the second device control unit 66, it is possible to more suitably input the second control information to the second device control unit 66.

In addition, the embodiments described above merely shows one aspect of the invention, and can be randomly modified and applied within the scope of the invention.

For example, in the embodiment described above, the invention has been described using a case where the POS system 1 is applied to the shop having the register counter L as an example. The aspect of the use of the POS system is not limited to this example, and may be applied to an eating and drinking place such as a coffee shop, or a restaurant. In addition, for example, the control apparatus 11 and the POS server 17 are separate devices, however, the control apparatus 11 may have the function of the POS server 17. In addition, for example, the control apparatus 11 is the thermal printer, however, may be any having a recording format.

In addition, for example, each functional block shown in FIGS. 2 to 4 can be randomly realized by a cooperation of hardware and software, and does not suggest a specific hardware configuration. In addition, each device may execute various operations by executing a program stored in an externally connected storage medium.

What is claimed is:

1. A device control apparatus comprising:
a first communicator that communicates with a terminal;
a second communicator that communicates with a device;
a first device controller on which a first control module corresponding to the device is mounted;
a second device controller that uses a second control module that is able to correspond to the device; and
a process controller that selects the first device controller or the second device controller based on control information received from the terminal by the first communicator, generates a command based on the control information, and transmits the generated command to the device by the second communicator.

2. The device control apparatus according to claim 1, further comprising:
a storage that stores device control management information indicating a correspondence between a device identifier for identifying the device and the first device controller or the second device controller,
wherein the process controller selects the first device controller or the second device controller by referring to the device control management information of the storage based on the device identifier included in the control information received from the terminal, and transmits the command to the device designated by the device identifier included in the control information.

3. The device control apparatus according to claim 2,
wherein the storage has device communication management information indicating a correspondence between the device identifier and the terminal, and
wherein the process controller determines whether or not the device designated by the device identifier included in the control information is able to execute communication, by referring to the device communication management information of the storage based on the device identifier included in the control information received from the terminal, and in a case where it is determined that the device designated by the device identifier is able to execute the communication, the process controller selects the first device controller or the second device controller.

4. The device control apparatus according to claim 3,
wherein the process controller is able to execute at least one of an addition, an update, and a deletion of the device control management information and the device communication management information stored in the storage based on management information received from the terminal by the first communicator.

5. The device control apparatus according to claim 1,
wherein the process controller includes:
a selector that selects the first device controller and the second device controller,
a first process controller that transmits the command to the device based on a process result of the first control module mounted on the first device controller in a case where the first device controller is selected by the selector, and
a communication module that transmits second device control information to the second device controller based on the control information received from the terminal in a case where the second device controller is selected by the selector, and
wherein the second device controller generates control data corresponding to the second control module based on the second device control information received from the communication module.

6. The device control apparatus according to claim 5, further comprising:
a table that defines the control data for each second control module,
wherein the second device controller converts the second device control information received from the communication module into the control data corresponding to the second control module, by referring to the table.

7. The device control apparatus according to claim 5,
wherein the second control module generates a unique command to the device based on the control data input from the second device controller.

8. The device control apparatus according to claim 5,
wherein the communication module is configured as a wrapper for relaying communication between the process controller and the second device controller.

9. A method of controlling a device control apparatus including a first communicator that communicates with a terminal and a second communicator that communicates with a device, the method comprising:
selecting a first device controller on which a first control module corresponding to the device is mounted or a second device controller that uses a second control module that is able to correspond to the device based on control information received from the terminal by the first communicator;
generating a command based on the control information received from the terminal; and
transmitting the generated command to the device by the second communicator.
